(19) United States
(12) Patent Application Publication
(10) Pub. No.: US 2024/0289747 A1
(43) Pub. Date: Aug. 29, 2024

(54) SYSTEM AND METHOD TO HELP STUDENTS IN CRISIS

(71) Applicant: Mirza Muhammad Ajmal Beg, Calgary (CA)

(72) Inventor: Mirza Muhammad Ajmal Beg, Calgary (CA)

(21) Appl. No.: 18/582,645

(22) Filed: Feb. 21, 2024

Related U.S. Application Data
(60) Provisional application No. 63/486,991, filed on Feb. 26, 2023.

(51) Int. Cl. G06Q 10/10

(52) U.S. Cl. CPC G06Q 10/103

(57) ABSTRACT

A system and computer-implemented method to provide help one or more students in one or more crises and comprising: a module to manage earned points by the student or another person on the student's behalf by using one or more rules, a module to manage consumption of the earned points by the student by using one or more rules, a module to convert one type of the earned points into another type of earned points by using one or more rules, a module to transfer the earned point by using one or more rules, and a module to generate a schedule to earn points to compensate for insufficient points consumed points.

### CROSS REFERENCE TO RELATED APPLICATIONS

This application claims priority of U.S. Provisional Application No. 63/486,991 (SYSTEM AND METHOD TO HELP STUDENTS IN CRISIS) filed Feb. 26, 2023 which is further based on U.S. 63/314,422 (SYSTEM AND METHOD TO HELP STUDENTS IN CRISIS) filed Feb. 27, 2022. U.S. Provisional Application No. 63/486,991 is incorporated herein by reference.

### BACKGROUND OF THE INVENTION

### Field of the Invention

The present invention is directed to a system and computer-implemented method to help one or more students in one or more crises.

### Description of the Related Art

Many students face short term one or more crises (such as temporary loss of place to live and unexpected sickness) and are unable to secure immediate help as traditional students' help in form of one or more scholarships and/or one or more grants have one or more strict eligibility criteria, one or more processing may take significant time and the help provided may be usually limited and in form of financial help. There is need for an alternative way to provide help swiftly to one or more students when they are in one or more crises.

### SUMMARY OF THE INVENTION

In one exemplary embodiment of the present invention, one or more students earn one or more points by conducting one or more point earning activities. In another exemplary embodiment of the present invention, other persons such as a parent, a sibling, a friend or other volunteer earn one or more points by conducting one or more point earning activities. In another exemplary embodiment of the present invention, the one or more earned points are transferred from one or more Programs to another one or more Programs with the movement of one or more Student Program Participants. In another embodiment of the present invention, the student consumes the earned one or more points when the one or more point consumption is added to the system. In another embodiment of the present invention, one type of one or more earned points are converted into another type of one or more earned points. In another embodiment, one or more schedules of one or more point earning activities is generated to enable earn insufficient one or more points for the help received.

### BRIEF DESCRIPTION OF THE DRAWINGS

FIG. 1 shows a block diagram of an example computer used to provide computing functionalities to implement the present invention. FIG. 2 illustrates an exemplary data model used by the system and the computer implemented method. FIG. 3 is a diagram conceptually illustrating an exemplary system according to the present invention. FIG. 4 is a diagram conceptually illustrating an exemplary calculation of one or more earned points for one or more point earning activities according to the present invention. FIG. 5 is a flow chart illustrating an exemplary operation of earning one or more points according to the present invention. FIG. 6 is a flow chart illustrating an exemplary operation of consuming one or more earned points by one or more Student Program Participants in one or more crises according to the present invention.

### DETAILED DESCRIPTION OF THE INVENTION

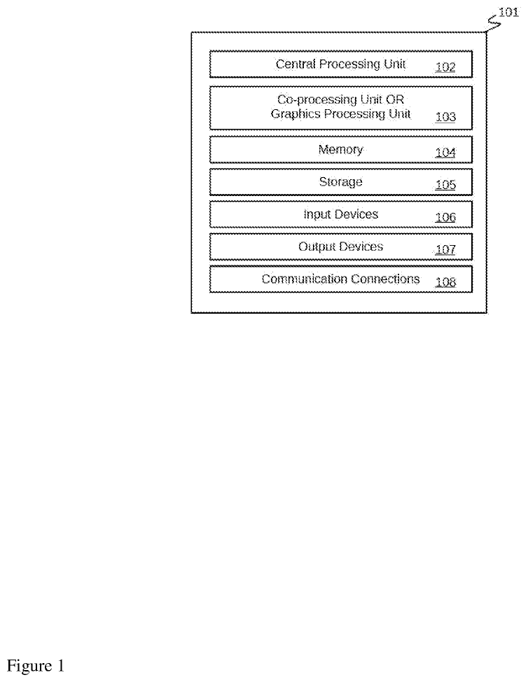

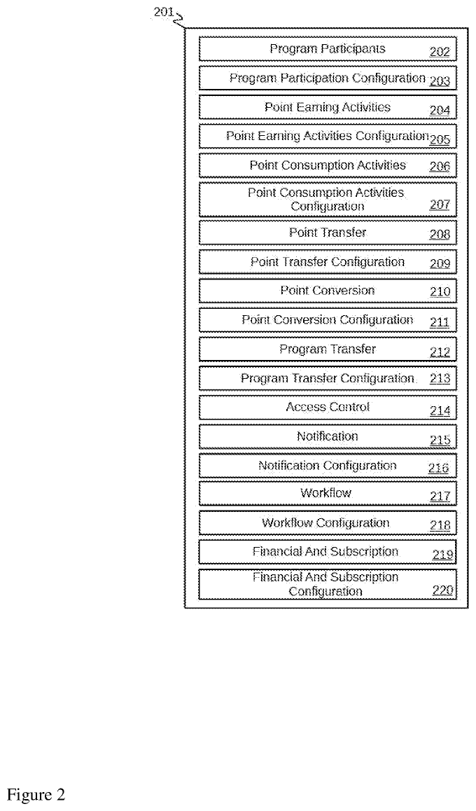

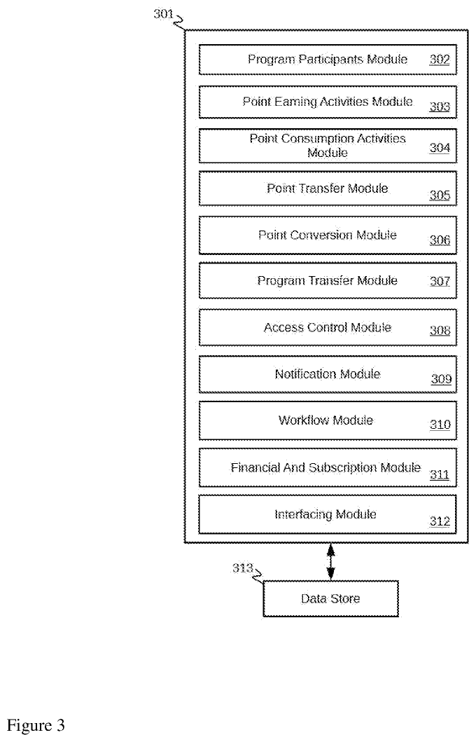

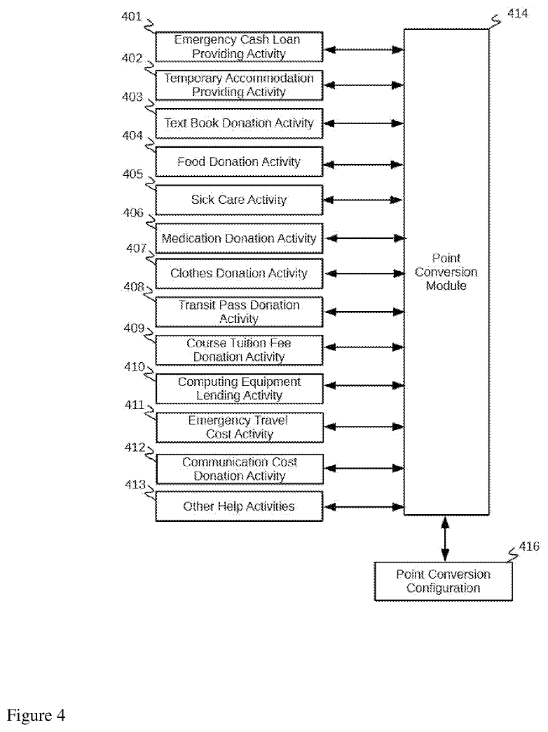

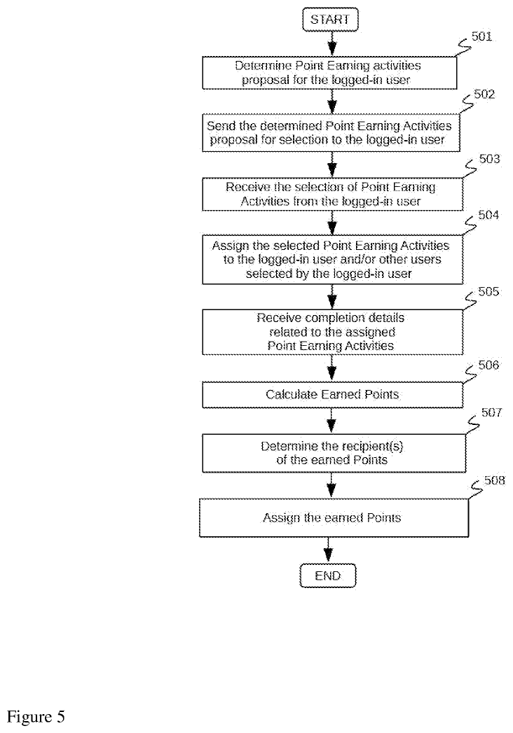

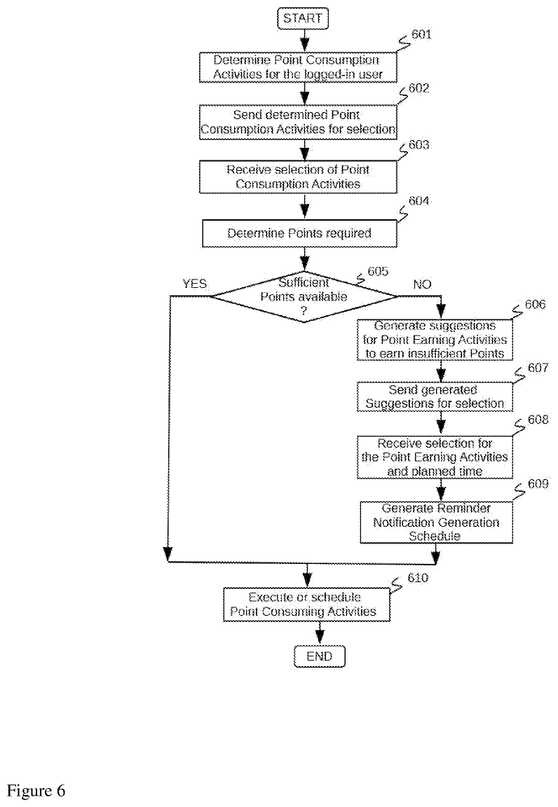

FIG. 1 shows a block diagram of an example computer 101 used to provide computing functionalities to implement the present invention. Computing devices such as laptop, workstation, laptops, distributed computing systems, desktop, server, cluster, virtual machine, mainframe, smart phone, wireless data port, a personal digital assistance, tablet computing devices are examples of such computer 101. The computer 101 includes a Processor 102 (e.g., a central processing unit (CPU), microprocessor, a digital signal processor (DSP), a conventional processor, a virtual process, micro-controller, virtual machine, a graphic processing unit (GPU), a radio-frequency integrated circuit (RFIC), an application specific integrated circuit (ASIC) or any suitable combination thereof). Processor 102 can be a multi-core processor or a plurality of multi-core processors. Memory 103 can be any kind of one or more memory devices such as read only memory (ROM), random access memory (RAM), optical, magnetic and flash memory. In some implementation, Memory 103 can be combination of two or more different types of memory. Memory 103 is shown as integral part of the computer 101, in alternative implementation memory 103 can be external to computer 101. Storage device 104 can be any medium which can be used as persistence storage. For example, hard drive, tape drive, optical disk drive, USB, flash driver and disk arrays. The storage device 104 is not limited to a particular storage device and may include memory devices such as ROM, RAM, hard disk, and the like. The storage device 104 may be one or more cloud storage devices. Input device 105 is used to input external data and can be any kind of device such as mouse, trackball, light pen, bio-metric mechanism including voice recognition. Output device 106 can be any kind of device used for data output. For example, cathode-ray-tube (CRT) monitor, plasma display, crystal display, projector, printer and speaker. Communication interface 107 can be one or more interfaces to any kind of networks such as internet, intranet, local area network, wide area network, a telephone network such as Public Switched Telephone Network, or combination of different kinds of networks. In some embodiments, the storage device 104 may connect to the example computer 101 using communication interface 107. The example computer system 101 can be a virtual machine or a cloud based computing device. The expression “or” is not exclusive throughout the specification.

FIG. 2 illustrates an exemplary data model 201 used by the system and the computer implemented method. The data model Program Participants 202 stores data related to Program Participants. A Program Participant is one or more educational organizations which provide one or more educational services and/or one or more educational products and use system 301. The expression “organization” here may also refer to one or more organizational units. One or more organizations may be in one or more hierarchical relationships. One or more processes which facilitate help to one or more students in one or more by using system 301 is referred as “Program”. A Program may ideally have more than one educational organizations as Program Participants. The data model Program Participation Configuration 203 may store data such as one or more data schema, constraints, filters, insights, rules, default values, validations, types, format information, presentation templates and other configuration data which is used to create, read, delete and update data related to the data model Program Participants 202. A Student Program Participant is a current student who is entitled to consume one or more entitlements to one or more earned points while facing one or more crises. The data model Point Earning Activities 204 stores data related to one or more activities that one or more Student Program Participants or someone else on behalf of the one or more Student Program Participants conduct to earn one or more points for consumption while facing one or more crises. The data model Point Earning Activities 204 also includes data related to one or more earned points and related data. The data model Point Earning Activities Configuration 205 my store data such as one or more data schema, constraints, filters, insights, rules, default values, validations, types, format information, presentation templates and other configuration data which is used to create, read, delete and update data related to the data model Point Earning Activities 204. The expressions “point” and “points” refer to one or more points represented by one or more numerical values and/or by one or more literal expressions. The expressions “activity” and “activities” refer to one or more activities. The data model Point Consumption Activities 206 stores data related to one or more activities that are carried out by one or more Student Program Participants in one or more crises which result in consumption of the one or more earned points. The data model Point Consumption Activities 206 also includes data related to one or more points consumed and related data. The data model Point Consumption Activities Configuration 207 may store data such as one or more data schema, constraints, filters, insights, rules, default values, validations, types, format information, presentation templates and other configuration data which is used to create, read, delete and update data related to the data model Point Consumption Activities 206. The data model Point Transfer 208 stores data related to transfer of earned points or points that are planned to be earned among multiple Student Program Participants. The data model Point Transfer Configuration 209 may store data such as one or more data schema, types, constraints, filters, insights, rules, default values, validations, format information, presentation templates and other configuration data which is used to create, read, delete and update data related to the data model Point Transfer 208. The data model Point Conversion 210 stores data related to conversion among one or more types of one or more earned points. The data model Point Conversion Configuration 211 may store data such as one or more data schema, constraints, filters, insights, rules, default values, validations, types, format information, presentation templates and other configuration data which is used to create, read, delete and update data related to the data model Point Conversion 210. The data model Notification 215 stores data related to one or more notifications generated for the one or more Student Program Participants and/or Program Participants. The data model Notification Configuration 216 may store data such as one or more data schema, constraints, filters, insights, rules, default values, validations, types, format information, presentation templates and other configuration data which is used to create, read, delete and update data related to the data model Notification 215. The data model Program Transfer 212 stores data related to transfer of one or more points earned at one or more external Programs to the current Program. The data model Program Transfer 212 also stores data related to one or more Student Program Participants transferring one or more earned points to the one or more external Programs. The data model Program Transfer Configuration 213 may store data such as one or more data schema, constraints, filters, insights, rules, default values, validations, types, format information, presentation templates and other configuration data which is used to create, read, delete and update data related to the data model Program Transfer 212. The data model Workflow 217 stores data related to approval and rejection one or more workflows. The data model Workflow Configuration 218 may store data such as one or more data schema, constraints, filters, insights, rules, default values, validations, types, format information, presentation templates and other configuration data which is used to create, read, delete and update data related to the data model Workflow 217. The data model Financial And Subscription Transaction 219 stores data related to one or more financial transactions such as one or more payments, one or more donations one or more membership for the Program. The data model Financial And Subscription 219 also stores data related to one or more subscriptions such as one or more payments, one or more donations one or more membership for the Program. The data model Financial And Subscription Configuration 220 may store data such as one or more data schema, constraints, filters, insights, rules, default values, validations, types, format information, presentation templates and other configuration data which is used to create, read, delete and update data related to the data model Financial And Subscription 219. The data model Access Control 214 stores data related to access control.

It is a well known art that the data models can be merged, split and given a different name that presented here. Such variation are within the scope of the invention.

FIG. 3 is a diagram conceptually illustrating an exemplary system 301 according to the present invention. The exemplary system 301 stores information in data store 313. The data store 313 can be one or more distributed data stores. The data store 313 may store partial or all data in one or more cloud based data stores. The exemplary system 301 generally consists of multiple modules 302-312. It is a known art to a person skilled in the art that the modules can be split, merged and renamed. All such variations are within scope of the invention. It is a known art to a person skilled in the art that a ‘module’ can be replaced with other means of grouping relevant computer instructions such as in form of function, subroutine, routine, component, services and micro-services. All such variations known to a person skilled in the art are within the scope of the present invention. It is also a known art that modules can be distributed on multiple computing environments. Such variations known to a person skilled in the art are within the scope of the present inventions.

The Program Participants Module 302 contains computer instructions to read, write, update and delete data related to one or more program participants by mainly using the data model Program Participants 202 and the data model Program Participation Configuration 203. The Program Participants Module 302 further contains computer instructions to perform one or more acts of:
(a) Classifying one or more program participants into one or more categories, optionally based on stored one or more rules, wherein the one or more categories may be associated with one or more category hierarchies.
(b) Classifying one or more program participants into into one or more domains, optionally based on stored one or more rules, wherein the one or more domains may be associated with one or more domain hierarchies.
(c) Associating the one or more categories of the one or more program participants to the one or more domains of the one or more program participants, optionally based on stored one or more rules.
(d) Identifying one or more prospect program participants, optionally based on stored one or more rules.
(e) Determining eligibility for the one or more prospect program participants and one or more program participants, optionally based on stored one or more rules.
   Ranking the one or more program participants, optionally based on stored one or more rules.

The Point Earning Activities Module 303 contains computer instructions to read, write, update and delete data related to one or more point earning activities by mainly using the data model Point Earning Activities 204 and the data model Point Earning Activities Configuration 205. The Point Earning Activities Module 303 may further contains computer instructions to perform acts of:
(a) Classifying one or more point earning activities into one or more categories, optionally based on stored one or more rules, wherein the one or more categories are associated with one or more category hierarchies.
(b) Classifying one or more point earning activities into one or more domains, optionally based on stored one or more rules, wherein the one or more domains are associated with one or more domain hierarchies.
(c) Associating the one or more categories of the one or more point earning activities to the one or more domains of the one or more point earning activities, optionally based on stored one or more rules.
(d) Identifying one or more prospect point earning activities, optionally based on stored one or more rules.
(e) Determining eligibility for the one or more prospect point earning activities and one or more point earning activities, optionally based on stored one or more rules.
(f) Ranking the one or more point earning activities based on stored one or more rules.
(g) Generating one or more proposals for one or more point earning activities with or without considering one or more point earning for one or more Student Program Participants also optionally based on stored one or more rules.
(h) Assigning one or more point earning activities with or without planned one or more completion time, optionally based on stored one or more rules.
   Determining completion status of assigned one or more point earning activities optionally based on stored one or more rules.
(i) Calculating the earned points by using determined completion status of assigned one or more point earning activities, optionally based on stored one or more rules.

The Point Consumption Activities Module 304 contains computer instructions to read, write, update and delete data related to one or more point consumption activities by mainly using the data model the module Point Consumption Activities 206 and the data model Point Consumption Activities Configuration 207. The Point Consumption Activities Module 304 may further contain computer instructions to perform acts of:
(a) Classifying one or more point consumption activities into one or more categories, optionally based on stored one or more rules, wherein the one or more categories are associated with one or more category hierarchies.
(b) Classifying one or more point consumption activities into one or more domains, optionally based on stored one or more rules, wherein the one or more domains are associated with one or more domain hierarchies.
(c) Associating the one or more categories of the one or more point consumption activities to the one or more domains of the one or more point consumption activities, optionally based on stored one or more rules.
   Identifying one or more prospect point consumption activities, optionally based on stored one or more rules.
(d) Determining eligibility for the one or more prospect point consumption activities and one or more point consumption activities, optionally based on stored one or more rules.
(e) Ranking the one or more point consumption activities, optionally based on stored one or more rules.
(f) Generating one or more proposals for one or more point consumption activities for one or more Student Program Participants, optionally based on stored one or more rules.
(g) Assigning one or more point consumption activities with and without one or more schedules for the assigned one or more point consumption activities, optionally based on stored one or more rules.
(h) Determining completion status of assigned one or more point consumption activities optionally based on stored one or more rules.
(i) Calculating the consumed points by using determined completion status of assigned one or more point consumption activities, optionally based on stored one or more rules.

The Point Transfer Module 305 contains computer instructions to read, write, update and delete data related to one or more point transfers by mainly using the data model Point Transfer 208 and the data model Point Transfer Configuration 209. The Point Transfer Module 305 may contain further computer instructions to perform acts of:
(a) Determining eligibility for the one or more point transfers, optionally based on stored one or more rules.
(b) Ranking the one or more point transfers, optionally based on stored one or more rules.

The Point Conversion Module 306 contains computer instructions to read, write, update and delete data related to point conversion by mainly using the data model Point Conversion 210 and the data model Point Conversion Configuration 211. The Point Conversion Module 305 may contain further computer instructions to perform acts of:
(a) Determining eligibility for the one or more point conversions, optionally based on stored one or more rules.
(b) Ranking the one or more point conversions, optionally based on stored one or more rules.
(c) Dynamically changing the one or more point conversions, optionally based on stored one or more rules.
(d) Evaluating suggestions related to one or more point conversions optionally based on stored one or more rules.

The Program Transfer Module 307 contains computer instructions to read, write, update and delete data related to program transfer by mainly using the data model Program Transfer 212 and the data model Program Transfer Configuration 213. The Program Transfer Module 305 may contain further computer instructions to perform acts of:
(a) Determining eligibility for the one or more program transfers using, optionally based on stored one or more rules.
(b) Ranking the one or more program transfers, optionally based on stored one or more rules.

The Access Control Module 308 contains computer instructions to read, write, update and delete data related to access control by using the data model Access Control 214. The Access Control Module 308 may control access to the system 301 using one or more ways such as: using one or more certificates, using one or more session keys, using one or more bio-metric data, using one or more user passwords, using one or more single sign-on methods, using one or more password wallets, using one or more cookies, using one or more stored configurations and using two (plus) factors authentications.

The Notification Module 309 contains computer instructions to read, write, update and delete data related to notifications by mainly using the data model Notification 215 and the data model Notification Configuration 216. The Notification Module 309 also issues one or more notifications including one or more reminder notifications, optionally based on one or more stored rules.

The Workflow Module 310 contains computer instructions to read, write, update and delete data related to workflow by mainly using the data model Workflow 217 and the data model Workflow Configuration 218. The module Financial And Subscription Module 311 contains computer instructions to read, write, update and delete data related to one or more financial transactions and/or one or more subscriptions by mainly using the data model Financial And Subscription 219 and the data model Financial And Subscription Configuration 220. The module Interfacing Module 312 contains computer instructions which enable use of different modules 302-311 by the users of system 301. The module Interfacing Module 312 may also enable interaction with the system 301 through one or more graphical user interfaces such as use of one or more portals, one or more mobile apps running on one or more mobile phones, tablets and laptops. The module Interfacing Module 312 may further enable interaction with the system 301 through one or more APIs. The data received by the module Interfacing Module 312 through one or more APIs may go through one or more extract transfer load (ETL) and/or extract load transfer (ELT) processes.

FIG. 4 is a diagram conceptually illustrating an exemplary one or more calculations of one or more earned points for one or more point earning activities according to the present invention. The act of creating data related to Emergency Cash Loan Providing Activity 401 results in generation of one or more earned points by giving one or more emergency cash loans to one or more Student Program Participants with urgent need of cash. The act of generating data related to Temporary Accommodation Providing Activity 402 results in generation of one or more earned points followed by one or more actual and/or reserved acts of providing one or more temporary accommodations to one or more Student Program Participants in one or more crises who need one or more temporary shelters. The act of creating data related to Text Book Donation Activity 403 results in generation of one or more earned points in the system 301 followed by an actual and/or reserved acts of donating one or more text books to one or more Student Program Participants in one or more crises who urgently need one or more text books but don't have money to purchase those. The act of creating data related to Food Donation Activity 404 results in generation of one or more earned points followed by one or more actual and/or reserved acts of donating one or more foods to one or more Student Program Participants in one or more crises who do not have money to buy one or more food items. The act of creating data related to Sick Care Activity 405 results in generation of one or more earned points in the system 301 followed by one or more actual and/or reserved acts of providing care to one or more Student Program Participants in one or more crises who do have anyone to take care of them during sickness. The act of creating data related to Medication Donation Activity 406 results in generation of one or more earned points in the system 301 followed by one or more actual and/or reserved acts of buying one or more medications for one or more Student Program Participants in one or more crises who do not have money to buy one or more medications. The act of creating data related to Clothes Donation Activity 407 results in generation of one or more earned points in the system 301 followed by one or more actual and/or reserved acts of donating warm clothes to one or more Student Program Participants in one or more crises who cannot buy one or more warm clothes for winter. The act of creating data related to Transit Pass Donation Activity 408 results in generation of one or more earned points in the system 301 followed by one or more actual and/or reserved acts of donating one or more Transit Passes to one or more Student Program Participants in one or more crises who do not have money to buy a Transit Pass. The act of creating data related to Course Tuition Fee Donation Activity 409 results in generation of one or more earned points followed by one or more actual and/or reserved acts of contributing toward one or more courses tuition for one or more Student Program Participants in one or more crises who is not able to pay one or more courses tuition fee. The act of creating data related to Computing Equipment Lending Activity 410 results in generation of one or more earned points in the system 301 followed by one or more actual and/or reserved acts of lending laptop to one or more Student Program Participants in one or more crises who lost their one or more laptops and do not have money to buy one or more new laptops. The act of creating data related to Emergency Travel Cost Activity 411 results in one or more earned points in the system 301 followed by one or more actual and/or reserved acts of sharing cost of one or more emergency travels for one or more Student Program Participants in one or more crises who need to travel in emergency and do not have money for the travel. The act of creating data related to Communication Cost Donation Activity 412 results in generation of one or more earned points followed by one or more actual and/or reserved acts of paying one or more communication costs such as one or more internet bills for one or more Student Program Participants in one or more crises who cannot pay internet bill. The act of creating data related to Other Help Activities 413 results in generation of one or more earned points in the system 301 followed by one or more actual and/or reserved acts of conducting other one or more activities. The module Point Conversion Module 414 converts one or more activities into different types of one or more earned points. In an exemplary usage: a Student Program Participant's activity of lending 100 dollars for 30 days is translated into 3000 dollar-day earned points (3000 dollar-days=100 dollars*30 days). With this activity, the same Student Program Participant becomes entitles to consume 3000 dollar-day earned points when in one or more crises. This 3000 dollar-day earned points can be consumed in one or more ways such as an emergency loan of 500 dollars for 6 days (3000 dollar-days=500 dollars for 6 days) or 200 dollars loan for 15 days (3000 dollar-days=200 dollars*15 days) when in one or more financial crises. In another exemplary usage: a program participant C provides 10 meals to another program participant D in need through the program. This activity entitles the program participant for 50 dollars points (10 meals at a cost of 5 dollars per meal) emergency help when in one or more financial crises. The program participant C can consume this 50 dollar points in multiple ways such as have his/her course tuition fee reduced by 50 dollars when the program participant C is in one or more financial crises.

FIG. 5 is a flow chart illustrating an exemplary operation of earning one or more points according to the present invention. The system 301 determines one or more point earning activities for logged-in one or more user (act 501). The system 301 sends the determined one or more point earning activities as proposal for selection to the one or more logged-in users (act 502). The system 301 receives the selection of one or more point earning activities from the logged-in user for earning one or more points (act 503). The system 301 assigns the selected point earning activities to the logged-in user and/or other users selected by the logged-in user (act 504). The system 301 receives completion details related to the assigned one or more point earning activities (act 505). The received completion details may also come from one or more logged-in users who are not logged-in users of act 504. The system 301 calculates the one or more earned points for partially or fully completed the assigned one or more point earning activities (act 506). The system 301 determines one or more recipients of the one or more earned points (act 507) based on one or more user selections and/or stored data. The system 301 assigns the one or more earned points (act 508) to the one or more recipients. The one or more recipients do not need to be the same one or more persons who completed the one or more point earning activities. Other persons such as a parent, a sibling, a friend or other volunteer can conduct one or more point earning activities to earn one or more points for one or more Student Program Participants who are in one or more crises.

FIG. 6 is a flow chart illustrating an exemplary operation of consuming points by a Student Program Participant in one or more crises according to the present invention. The system 301 determines one or more point consuming activities for the logged-in user (Student Program Participant in one or more crises in this example) (act 601). The system 301 sends the determined point consuming activities for selection to the logged-in user (act 602). The system 301 receives one or more selections of one or more point consuming activities (act 603). The system 301 determines points required for the selection of one or more point consuming activities (act 604). In case, there are sufficient one or more earned points available for the selection of one or more point consuming activities, execute or schedule the selection of one or more point consuming activities (act 605) (act 610). The example of executing a selection of one or more point consuming activities include transferring one or more emergency cash loans. The example of scheduling the selection of one or more point consuming activities include generating one or more schedules for a caring one or more sick Student Program Participants needing care. In case, there are not sufficient one or more earned points available for the one or more selections of the one or more point consuming activities, the system 301 generates one or more suggestions for one or more additional point earning activities to earn insufficient one or more points (act 605) (act 606). The system 301 sends generated one or more suggestions for selection of one or more additional point earning activities to the logged-in user (act 607). The system 301 receives one or more selections for the one or more additional point earning activities and one or more planned times for conducting the additional point earning activities (act 608). The system 301 generates one or more reminder notification generation schedules (act 609). The system 301 assigns and/or schedules the generated one or more point consumption activities (act 610).

The one or more stored rules used by one or more modules may be based on one or more models developed by one or more self-learning algorithms with or without human interventions.

It is a well known art that acts/steps in flow chart can be split, merged and reordered. Such variations to flow in FIG. 4 is within scope of the invention.

It is to be understood that while the detailed description describes the present invention, the foregoing description is for illustrative purpose and does not limit the scope of the present invention which is defined by the scope of the appended claims. Other embodiments, arrangements and equivalents will be evident to those skilled in the art. Such other embodiments, arrangements and equivalents are within the scope of the present invention as defined by the appended claims.

1. A system for helping students in one or more crisis using earned points, the system comprising:
one or more processors coupled to one or more memories;
stored one or more program participants data and related stored configuration data;
stored one or more point earning activities data and related stored configuration data;
stored one or more point consumption activities data and related stored configuration data;
stored one or more point conversions data and related stored configuration data;
stored one or more point transfers data and related stored configuration data;
stored one or more approval and rejection workflows data and related stored configuration data;
stored one or more subscriptions data and related stored configuration data;
stored one or more access control data; and
one or more computer-executable instructions configured to control access to the system.

2. The system of claim 1, further comprising at least one of:
one or more computer-executable instructions configured to classify one or more program participants into one or more categories with or without using one or more stored rules which are optionally based on one or more models developed by one or more self-learning algorithms with or without human interventions and from the stored configuration data related to the stored one or more program participants data;
one or more computer-executable instructions configured to classify one or more program participants into one or more domains with or without using one or more stored rules which are optionally based on one or more models developed by one or more self-learning algorithms with or without human interventions and from the stored configuration data related to the stored one or more program participants data;
one or more computer-executable instructions configured to associate one or more categories of one or more program participants to one or more domains of one or more program participants with or without using one or more stored rules which are optionally based on one or more models developed by one or more self-learning algorithms with or without human interventions and from the stored configuration data related to the stored one or more program participants data;
one or more computer-executable instructions configured to identify one or more prospect program participants with or without using one or more stored rules which are optionally based on one or more models developed by one or more self-learning algorithms with or without human interventions and from the stored configuration data related to the stored one or more program participants data;
one or more computer-executable instructions configured to determine eligibility for one or more prospect program participants and one or more program participants with or without using one or more stored rules which are optionally based on one or more models developed by one or more self-learning algorithms with or without human interventions and from the stored configuration data related to the stored one or more program participants data;
one or more computer-executable instructions configured to rank one or more program participants with or without using one or more stored rules which are optionally based on one or more models developed by one or more self-learning algorithms with or without human interventions and from the stored configuration data related to the stored one or more program participants data.

3. The system of claim 1, further comprising at least one of:
one or more computer-executable instructions configured to classify one or more point earning activities into one or more categories with or without using one or more stored rules which are optionally based on one or more models developed by one or more self-learning algorithms with or without human interventions and from the stored configuration data related to the stored one or more point earning activities data;
one or more computer-executable instructions configured to classify one or more point earning activities into one or more domains with or without using one or more stored rules which are optionally based on one or more models developed by one or more self-learning algorithms with or without human interventions and from the stored configuration data related to the stored one or more point earning activities data;
one or more computer-executable instructions configured to associate one or more categories of one or more point earning activities to one or more domains of one or more point earning activities with or without using one or more stored rules which are optionally based on one or more models developed by one or more self-learning algorithms with or without human interventions and from the stored configuration data related to the stored one or more point earning activities data;
one or more computer-executable instructions configured to identify one or more prospect point earning activities with or without using one or more stored rules which are optionally based on one or more models developed by one or more self-learning algorithms with or without human interventions and from the stored configuration data related to the stored one or more point earning activities data;
one or more computer-executable instructions configured to determine eligibility for one or more prospect point earning activities and one or more point earning activities with or without using one or more stored rules which are optionally based on one or more models developed by one or more self-learning algorithms with or without human interventions and from the stored configuration data related to the stored one or more point earning activities data;
one or more computer-executable instructions configured to rank one or more point earning activities with or without using one or more stored rules which are optionally based on one or more models developed by one or more self-learning algorithms with or without human interventions and from the stored configuration data related to the stored one or more point earning activities data;
one or more computer-executable instructions configured to generate one or more proposals for one or more point earning activities with or without considering one or more point earnings for one or more student program participants with or without using one or more stored rules which are optionally based on one or more models developed by one or more self-learning algorithms with or without human interventions and from the stored configuration data related to the stored one or more point earning activities data;
one or more computer-executable instructions configured to assign one or more point earning activities with or without planned one or more completion times with or without using one or more stored rules which are optionally based on one or more models developed by one or more self-learning algorithms with or without human interventions and from the stored configuration data related to the stored one or more point earning activities data;
one or more computer-executable instructions configured to determine completion status of assigned one or more point earning activities with or without using one or more stored rules which are optionally based on one or more models developed by one or more self-learning algorithms with or without human interventions and from the stored configuration data related to the stored one or more point earning activities data;
one or more computer-executable instructions configured to calculate earned points by using determined completion status of assigned one or more point earning activities with or without using one or more stored rules which are optionally based on one or more models developed by one or more self-learning algorithms with or without human interventions and from the stored configuration data related to the stored one or more point earning activities data.

4. The method of claim 1, further comprising at least one of:
one or more computer-executable instructions configured to classify one or more point consumption activities into one or more categories with or without using one or more stored rules which are optionally based on one or more models developed by one or more self-learning algorithms with or without human interventions and from the stored configuration data related to the stored one or more point consumption activities data;
one or more computer-executable instructions configured to classify one or more point consumption activities into one or more domains with or without using one or more stored rules which are optionally based on one or more models developed by one or more self-learning algorithms with or without human interventions and from the stored configuration data related to the stored one or more point consumption activities data;
one or more computer-executable instructions configured to associate one or more categories of one or more point consumption activities to one or more domains of one or more point consumption activities with or without using one or more stored rules which are optionally based on one or more models developed by one or more self-learning algorithms with or without human interventions and from the stored configuration data related to the stored one or more point consumption activities data;
one or more computer-executable instructions configured to identify one or more prospect point consumption activities with or without using one or more stored rules which are optionally based on one or more models developed by one or more self-learning algorithms with or without human interventions and from the stored configuration data related to the stored one or more point consumption activities data;
one or more computer-executable instructions configured to determine eligibility for one or more prospect point consumption activities and one or more point consumption activities with or without using one or more stored rules which are optionally based on one or more models developed by one or more self-learning algorithms with or without human interventions and from the stored configuration data related to the stored one or more point consumption activities data;
one or more computer-executable instructions configured to rank one or more point consumption activities with or without using one or more stored rules which are optionally based on one or more models developed by one or more self-learning algorithms with or without human interventions and from the stored configuration data related to the stored one or more point consumption activities data;
one or more computer-executable instructions configured to generate one or more proposals for one or more point consumption activities for one or more student program participants with or without using one or more stored rules which are optionally based on one or more models developed by one or more self-learning algorithms with or without human interventions and from the stored configuration data related to the stored one or more point consumption activities data;
one or more computer-executable instructions configured to assign one or more point consumption activities with and without one or more schedules for assigned one or more point consumption activities with or without using one or more stored rules which are optionally based on one or more models developed by one or more self-learning algorithms with or without human interventions and from the stored configuration data related to the stored one or more point consumption activities data;
one or more computer-executable instructions configured to determine completion status of assigned one or more point consumption activities with or without using one or more stored rules which are optionally based on one or more models developed by one or more self-learning algorithms with or without human interventions and from the stored configuration data related to the stored one or more point consumption activities data;
one or more computer-executable instructions configured to calculate consumed points by using determined completion status of assigned one or more point consumption activities with or without using one or more stored rules which are optionally based on one or more models developed by one or more self-learning algorithms with or without human interventions and from the stored configuration data related to the stored one or more point consumption activities data.

5. The system of claim 1, further comprising at least one of:
one or more computer-executable instructions configured to determine eligibility for one or more point transfers with or without using one or more stored rules which are optionally based on one or more models developed by one or more self-learning algorithms with or without human and interventions from the stored configuration data related to the stored one or more point transfers data;
one or more computer-executable instructions configured to rank one or more point transfers with or without using one or more stored rules which are optionally based on one or more models developed by one or more self-learning algorithms with or without human interventions and from the stored configuration data related to the stored one or more point transfers data.

6. The system of claim 1, further comprising at least one of:
one or more computer-executable instructions configured to determine eligibility for one or more point conversions with or without using one or more stored rules from the stored configuration data related to the stored one or more point conversions data;
one or more computer-executable instructions configured to rank one or more point conversions with or without using one or more stored rules which are optionally based on one or more models developed by one or more self-learning algorithms with or without human interventions and from the stored configuration data related to the stored one or more point conversions data;
one or more computer-executable instructions configured to dynamically change one or more point conversions with or without using one or more stored rules which are optionally based on one or more models developed by one or more self-learning algorithms with or without human interventions and from the stored configuration data related to the stored one or more point conversions data;
one or more computer-executable instructions configured to evaluate suggestions related to one or more point conversions with or without using one or more stored rules which are optionally based on one or more models developed by one or more self-learning algorithms with or without human interventions and from the stored configuration data related to the stored one or more point conversions data.

7. The system of claim 1, further comprising stored one or more program transfers data, related stored configuration data and at least one of:
one or more computer-executable instructions configured to determine eligibility for one or more program transfers with or without using one or more stored rules which are optionally based on one or more models developed by one or more self-learning algorithms with or without human interventions and from the stored configuration data related to the stored one or more program transfers data;
one or more computer-executable instructions configured to rank one or more program transfers with or without using one or more stored rules which are optionally based on one or more models developed by one or more self-learning algorithms with or without human interventions and from the stored configuration data related to the stored one or more program transfers data.

8. The system of claim 1, further comprising:
stored one or more financial data and related stored configuration data.

9. The system of claim 1, further comprising:
one or more computer-executable instructions configured to issue notifications with or without using one or more stored rules which are optionally based on one or more models developed by one or more self-learning algorithms with or without human interventions and from the stored configuration data related to the stored one or more notification data.

10. The system of claim 1, further configured to perform steps of:
determine one or more point earning activities for a logged-in user;
send the determined one or more point earning activities as proposal for selection to the logged-in user;
receive selection of one or more point earning activities from the logged-in user for earning one or more points;
assign the selected point earning activities to the logged-in user and/or other user selected by the logged-in user;
receive one or more completion details related to the assigned one or more point caring activities;
calculate one or more earned points for partially or fully completed the assigned one or more point earning activities;
determine one or more recipients of the one or more earned points based on one or more user selections and/or stored data;
assign the one or more earned points to the one or more determined recipients.

11. The system of claim 1, further configured to perform steps of:
determine one or more point consuming activities for a logged-in user;
send the determined one or more point consuming activities for selection to the logged-in user;
receive one or more selections of one or more point consuming activities;
determine one or more points required for the received one or more selections of the one or more point consuming activities;
execute or schedule the one or more selections of one or more point consuming activities when there are sufficient one or more earned points available;
generate one or more suggestions for one or more additional point earning activities to earn insufficient one or more points for the one or more selections of one or more point consuming activities when there are not sufficient one or more earned points available for the one or more selections of the one or more point consuming activities;
send the generated one or more suggestions for selection of the one or more additional point earning activities to the logged-in user;
receive one or more selections for the one or more additional point earning activities and one or more planned times for conducting the additional point earning activities;
generate one or more reminder notification generation schedules;
assign and/or schedule the generated one or more point consumption activities.

12. The system of claim 10, wherein the point earning activities comprising at least one of:
one or more emergency cash loan providing activities;
one or more temporary accommodation providing activities;
one or more text book donation activities;
one or more food donation activities;
one or more sick care activities;
one or more medication donation activities;
one or more clothes donation activities;
one or more transit pass donation activities;
one or more course tuition fee donation activities;
one or more computing equipment lending activities;
one or more emergency travel cost activities;
one or more communication cost donation activities.

13. A computer-implemented method for helping students in one or more crisis, comprising:
one or more processors coupled to one or more memories;
stored one or more program participants data and related stored configuration data;
stored one or more point earning activities data and related stored configuration data;
stored one or more point consumption activities data and related stored configuration data;
stored one or more point conversions data and related stored configuration data;
stored one or more point transfers data and related stored configuration data;
stored one or more approval and rejection workflows data and related stored configuration data;
stored one or more subscriptions data and related stored configuration data;
stored one or more access control data;
one or more computer-executable instructions configured to control access to the computer-implemented method.

14. The method of claim 13, further comprising stored one or more program transfers data, related stored configuration data and configured to perform at least one of:
determine eligibility for one or more program transfers with or without using one or more stored rules which are optionally based on one or more models developed by one or more self-learning algorithms with or without human interventions and from the stored configuration data related to the stored one or more program transfers data;
rank one or more program transfers with or without using one or more stored rules which are optionally based on one or more models developed by one or more self-learning algorithms with or without human interventions and from the stored configuration data related to the stored one or more program transfers data.

15. The method of claim 13, further comprising:
stored one or more financial data and related stored configuration data.

16. The method of claim 13, further comprising:
one or more computer instructions configured to issue notifications with or without using one or more stored rules which are optionally based on one or more models developed by one or more self-learning algorithms with or without human interventions and from stored configuration data related to the stored one or more notification data.

17. The method of claim 13, further configured to perform steps of:
determining one or more point earning activities for a logged-in user;
sending the determined one or more point earning activities as proposal for selection to the logged in user;
receiving selection of one or more point earning activities from the logged-in user for earning one or more points;
assigning the selected point earning activities to the logged-in user and/or other user selected by the logged-in user;
receiving one or more completion details related to the assigned one or more point earning activities;
calculating one or more earned points for partially or fully completed the assigned one or more point earning activities;
determining one or more recipients of the one or more earned points based on one or more user selections and/or stored data;
assigning the one or more earned points to the one or more determined recipients.

18. The method of claim 13, further configured to perform steps of:
determining one or more point consuming activities for a logged-in user;
sending the determined one or more point consuming activities for selection to the logged-in user;
receiving one or more selections of one or more point consuming activities;
determining one or more points required for the received one or more selections of the one or more point consuming activities;
executing or scheduling the one or more selections of one or more point consuming activities when there are sufficient one or more earned points available;
generating one or more suggestions for one or more additional point earning activities to earn insufficient one or more points for the one or more selections of one or more point consuming activities when there are not sufficient one or more earned points available for the one or more selections of the one or more point consuming activities;
sending generated one or more suggestions for selection of the one or more additional point earning activities to the logged-in user;
receiving one or more selections for the one or more additional point earning activities and one or more planned times for conducting the additional point earning activities;
generating one or more reminder notification generation schedules;
assigning and/or scheduling the generated one or more point consumption activities.

19. The method of claim 17, wherein the point earning activities comprise at least one of:
one or more emergency cash loan providing activities;
one or more temporary accommodation providing activities;
one or more text book donation activities;
one or more food donation activities;
one or more sick care activities;
one or more medication donation activities;
one or more clothes donation activities;
one or more transit pass donation activities;
one or more course tuition fee donation activities;
one or more computing equipment lending activities;
one or more emergency travel cost activities;
one or more communication cost donation activities.

20. A non-transitory computer-readable medium with an executable-program stored thereon, wherein the executable-program is configured to instruct a computer/processor to perform the method of any of claim 13 to claim19.
